(19) United States
(12) Patent Application Publication
(10) Pub. No.: US 2011/0035516 A1
(43) Pub. Date: Feb. 10, 2011

(54) COMPUTER SYSTEM WITH DUAL HOSTS

(75) Inventors: Wen-Chou Liu, Taipei (TW); Chen-Wei Chiang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/849,821

(22) Filed: Aug. 4, 2010

(30) Foreign Application Priority Data
Aug. 6, 2009 (TW) 98126533

(51) Int. Cl. G06F 13/30; G06F 3/00

(52) U.S. Cl. 710/40; 710/51

(57) ABSTRACT

A computer system with dual hosts is provided. The computer system includes a body, a first host, a second host and multiple peripheral devices. The first host and the second host are configured in the body, and the peripheral devices are coupled to the first host and the second host. When the first host starts, the peripheral devices are controlled by the first host. When the second host starts and the first host does not start, the peripheral devices are controlled by the second host.

### CROSS-REFERENCE TO RELATED APPLICATION

This application claims the priority benefit of Taiwan application serial no. 98126533, filed on Aug. 6, 2009. The entirety of the above-mentioned patent application is hereby incorporated by reference herein and made a part of this specification.

### BACKGROUND OF THE INVENTION

1. Field of the Invention

The invention relates to a computer system and, more particularly, to a computer system with dual hosts.

2. Description of the Related Art

Portable devices commonly include notebook computers and personal digital assistants (PDA). The notebook computer has stronger calculation ability and consumes more power, and the PDA has weaker calculation ability but consumes less power.

Conventionally, a notebook computer and a PDA cooperate respectively with different sets of independent peripheral devices. Thus, a user has to carry both the notebook computer and the PDA when going out. This may cause inconvenience, and furthermore, since both the notebook computer and the PDA should be turned on for operation of system thereof if once required, the power consumption is increased, which conflict with the developing trend of being power saving.

### BRIEF SUMMARY OF THE INVENTION

The invention discloses a computer system with dual hosts, which allows two hosts use same peripheral devices alternatively according to a control priority.

The invention discloses a computer system with dual hosts including a body, a first host, a second host and multiple peripheral devices. The first host and the second host are configured in the body, and the peripheral devices are coupled to the first host and the second host, respectively. When the first host and the second host start at the same time, the first host has a control priority to control the peripheral device. When one of the first host and the second host starts operation and the other does not, the started host is then has the control priority to control the peripheral devices.

In an embodiment of the invention, the peripheral devices includes a display unit, an audio input/output unit, a storage unit and a connecting port.

In an embodiment of the invention, the computer system further includes a switching unit configured in the body, coupled to the first host and the second host and the peripheral devices for switching a control priority between the first host and the second host, thereby allowing the first host or the second host to control the peripheral devices. The switching unit herein is, for example, a multiplexer.

In an embodiment of the invention, when the first host and the second host start at the same time, the switching unit determines whether to allow the first host to control the peripheral devices according to a control priority of a packet transmitted between the first host and the second host. If the first host does not control the peripheral devices, the switching unit allows the second host to control the peripheral devices.

In an embodiment of the invention, the computer system further includes a signal transmitting unit coupled to the first host and the second host, respectively, for communicating with the first host and the second host. When the first host and the second host start at the same time, if the second host has to use the peripheral devices, the second host sends a signal to the first host via the signal transmitting unit to make the first host adjust it as secondary and allows a control priority to the second host.

In an embodiment of the invention, the computer system further includes an embedded control unit configured in the body and coupled to the first host and the second host and the switching unit. The embedded control unit transmits a first control signal to the switching unit when the first host starts, thereby makes the switching unit to choose the first host to control the peripheral devices. When the second host starts and the first host does not, the embedded control unit transmits a second control signal to the switching unit thereby makes the switching unit to choose the second host to control the peripheral devices.

In an embodiment of the invention, the second host includes a touch panel, and the first host controls the touch panel via the embedded control unit. The touch panel is, for example, a displayer. When the second host controls the peripheral devices, the second host transmits images to the displayer.

In an embodiment of the invention, the first host is, for example, a notebook computer, and the second host is, for example, a personal digital assistant (PDA), and the second host is embedded in the first host in a pluggable manner.

Based on the above illustration, the computer system with dual hosts in accordance with present invention, the two hosts are configured in the body to share the same set of peripheral devices. When a host starts and the other not, the started host controls the peripheral devices, and if two hosts start at the same time, the host that predetermined as the primary host has the control priority to control the peripheral devices.

These and other features, aspects and advantages of the present invention will become better understood with regard to the following description, appended claims, and accompanying drawings.

### BRIEF DESCRIPTION OF THE DRAWINGS

FIG. 1 is a block diagram showing an embodiment of the computer system in accordance with present invention;

FIG. 2 is a schematic diagram showing the appearance of the computer system in accordance with present invention;

FIG. 3A and FIG. 3B are block diagrams showing a second embodiment of the computer system in accordance with present invention; and

FIG. 4 is a block diagram showing a third embodiment of the computer system in accordance with present invention.

### DETAILED DESCRIPTION OF THE EMBODIMENTS

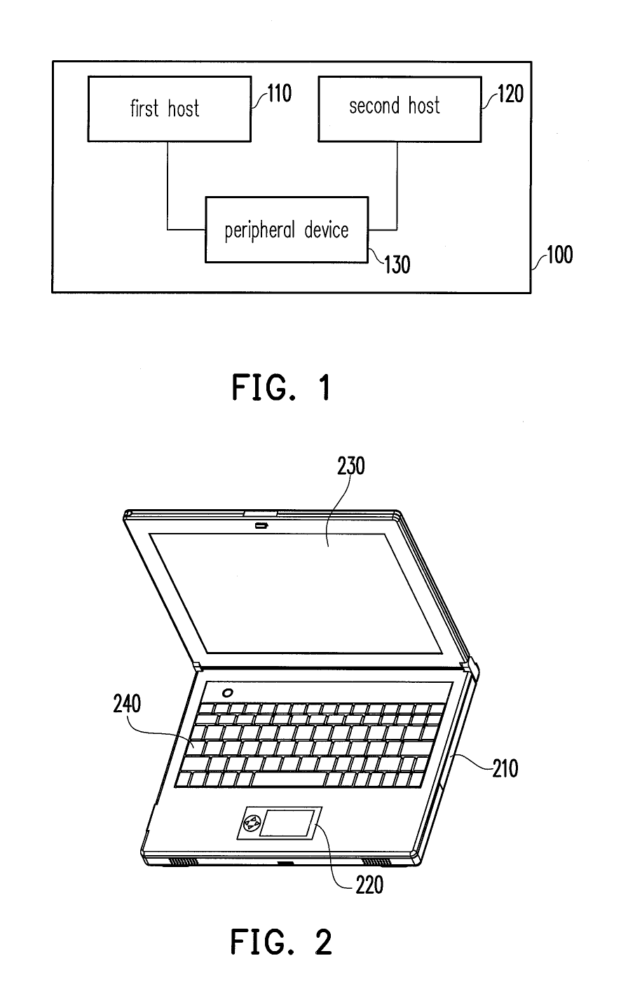

As shown in FIG. 1, in the embodiment, the computer system includes a body 100, a first host 110, a second host 120 and multiple peripheral devices 130. The first host 110, the second host 120 are configured in the body 100. The peripheral devices 130 are coupled to the first host 110 and the second host 120, respectively. The peripheral devices 130 include but not limited to, for example, a display unit, an audio input/output unit, a storage unit and/or a connecting port. In the embodiment, the peripheral devices 130 are configured in the body 100. Note that in other embodiments, the peripheral devices 130 also may be externally connected to the body 100.

The first host 110 is the primary host, and the second host 120 is a secondary host. When the first host 110 starts and the second host 120 does not, the first host 110 controls the peripheral devices 130. When the second host 120 starts and the first host 110 does not, the second host 120 controls the peripheral devices 130. In another aspect, when the first host 110 and the second host 120 start at the same time, the first host 110 preferentially controls the peripheral devices 130 according to a control priority. That is, the first host 110 which is implemented as the primary host has the control priority to control the peripheral devices 130.

In the embodiment, to facilitate the illustration, FIG. 1 only shows one peripheral device 130 that shared by the first host 110 and the second host 120. In practice, multiple peripheral devices are implemented, which is not limited herein.

The second host 120 is embedded in the first host 110 in a pluggable manner. For example, as shown in FIG. 2, in the embodiment, the first host 110 is, for example, a notebook computer 210 with an x86 architecture, and the second host 120 is, for example, a PDA 220 with an advanced RISC machine (ARM) architecture. The notebook computer 210 is the primary host. Since the notebook computer 210 consumes more power, when the user does not use the function of the notebook computer 210, he or she may embed the PDA 220 in the notebook computer 210 to perform operations by the PDA 220 with less power consumption. The PDA 220 may be embedded in the position for assembling the touch panel originally. Consequently, when the notebook computer 210 is not started, the PDA 220 controls the peripheral device (such as the screen 230 and the keyboard 240) of the notebook computer 210 to reduce the power consumption.

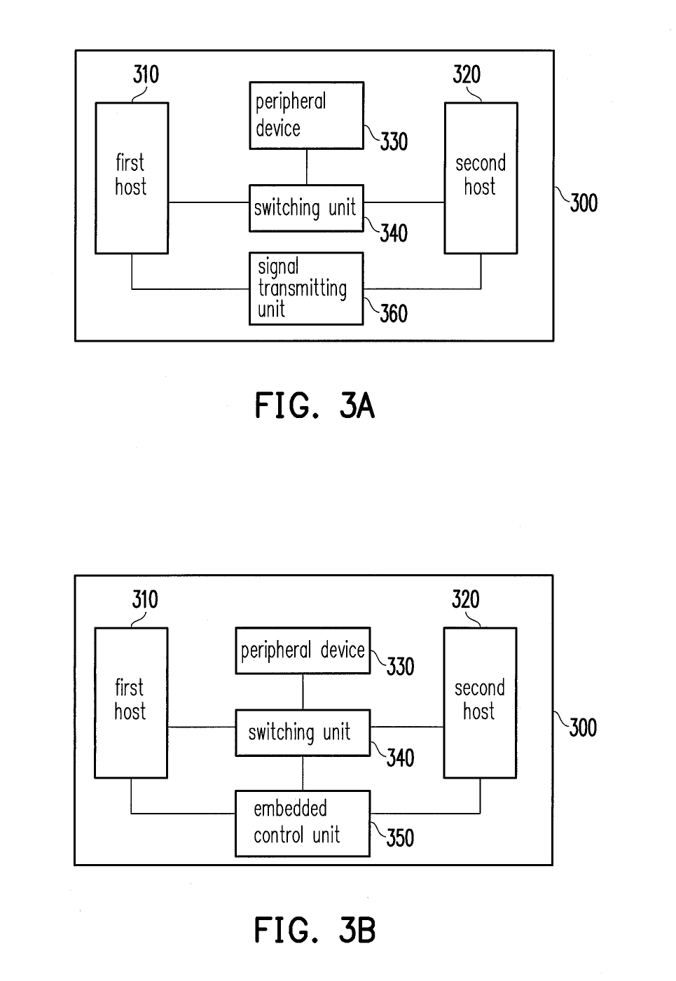

The following embodiments illustrate how to switch a control priority of the peripheral device between the two hosts. As shown in FIG. 3A, the body 300 of the computer system has a first host 310, a second host 320, multiple peripheral devices 330, a switching unit 340 and a signal transmitting unit 360. The switching unit 340 is coupled to the first host 310 and the second host 320, and the peripheral devices 330, respectively, and the signal transmitting unit 360 is coupled to the first host 310 and the second host 320. The peripheral devices 330 are coupled to the first host 310 and the second host 320 via the switching unit 340.

The switching unit 340 switches between the first host 310 and the second host 320 to determine whether the peripheral devices 330 are controlled by the first host 310 or the second host 320. For example, when the first host 310 and the second host 320 start at the same time, the switching unit 340 determines whether the first host 310 or the second host 320 controls the peripheral devices 330 according to a control priority contained in a packet transmitted by the first host 310 and the second host 320 (the control priority may be written in the flag of the packet). The switching unit 340 herein is, for example, a multiplexer.

The first host 310 and the second host 320 communicate with each other via the signal transmitting unit 360. When the first host 310 and the second host 320 start at the same time, since the first host 310 has the control priority, the first host 310 controls the peripheral devices 330. If the second host 320 tends to use the peripheral devices 330, it transmits a signal to the first host 310 via the signal transmitting unit 360 to notify the first host 310 to change the control priority and allow the second host 320 to use the peripheral devices 330.

In addition, the switching unit 340 also may be controlled by hardware. As shown in FIG. 3B, the body 300 of the computer system further has an embedded control unit 350 coupled to the first host 310, the second host 320 and the switching unit 340. The embedded control unit 350 controls the keyboard, the touch control chip and input units, and it also controls the switching unit 340 to switch. Detailedly, when the first host 310 starts, no matter the second host 320 starts or not, the embedded control unit 350 transmits a first control signal to the switching unit 340 to choose the first host 310 to control the peripheral devices 330. That is, the first host 310 has the priority to control the peripheral devices 330. When the second host 320 starts and the first host 310 does not, the embedded control unit 350 transmits the second control signal to the switching unit 340 to choose the second host 320 to control the peripheral devices 330.

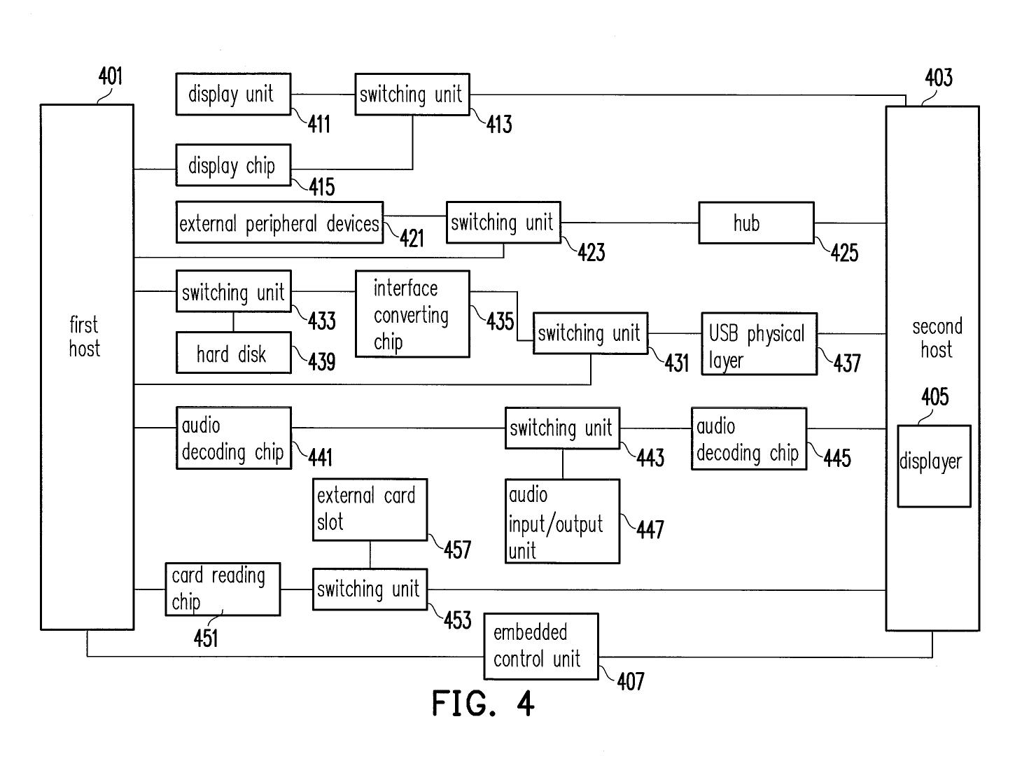

The following circuit diagram is an embodiment showing how the two hosts share multiple peripheral devices. As shown in FIG. 4, supposing that the first host 401 is the primary host, and the second host 403 is a secondary host. The peripheral devices includes a display unit 411, an audio input/output unit 447, an expansion card slot 457 and a hard disk 439 and an external peripheral device 421 (such as a camera and the wireless fidelity (WiFi) network).

The switching unit 413 is configured between the first host 401 and the second host 403 and used for connecting the display chip 415 and the display unit 411. The switching unit 423 is configured between the first host 401 and the second host 403 for connecting the external peripheral device 421 and the hub 425. The switching unit 433 is configured between the first host 401 and the second host 403 for connecting the hard disk 439 and the interface converting chip 435, and the switching unit 431 is connected to the interface converting chip 435 and the universal serial bus (USB) physical layer 437 in series. The switching unit 443 is configured among the first host 401, the second host 403 and the audio input/output unit 447, and the first host 401 and the second host 403 are connected to each other via the audio decoding chips 441, 445 and the switching unit 443, respectively. The switching unit 453 is configured between the first host 401 and the second host 403, and is adapted for connecting the card reading chip 451 and the expansion card slot 457.

When the first host 401 and the second host 403 start at the same time, the switching unit 413,423,433,443, or 453 determines which host controls the peripheral devices according to the control priority of the packet transmitted by the first host 401 and the second host 403. Said peripheral devices may include a display unit 411, an audio input/output unit 447, an expansion card slot 457, a hard disk 439 and an external peripheral device 421.

The display unit 411 is connected with the displayer 405, when the second host 403 obtains the control priority to control the peripheral devices, the second host 403 transmits images for displayed in the displayer 405 to the display unit 411 via the switching unit 413.

In addition, in the embodiment, the first host 401 further uses the displayer 405 of the second host 403 via the embedded control unit 407.

The switching unit 431 is used to alternatively transmit the signal to the interface converting chip 435 or the first host 401. Detailedly, when the switching unit 431 transmits the signal to the interface converting chip 435, the second host 403 is connected to the interface converting chip 435 via the USB physical layer 437 and the switching unit 431 to allow the second host 403 to use the hard disk 439 via the switching unit 433.

In addition, when the switching unit 431 transmits signals to the first host 401, the second host 403 communicates with the first host 401 via the USB physical layer 437 and the switching unit 431. When the first host 401 and the second host 403 start at the same time, if the second host 403 wants to use the peripheral device, the second host 403 informs the first host 401 via the switching unit 431 to change the control priority. For example, the user may send a command for switching the host via the displayer 405. With such, the second host 403 may control the peripheral device.

In addition, the first host 401 or the second host 403 may be set to boot the computer via a basic input output system (BIOS).

To sum up, the computer system has two hosts to share multiple peripheral devices. When a host starts and the other does not, the started host controls the peripheral devices. When the two hosts start, the host which is used as the primary host has the control priority to control the peripheral device. Therefore, the host with higher calculating ability can be combined with the host with lower calculating ability. When the function with higher calculation ability is not needed, the peripheral devices may be controlled by the host with lower calculating ability and lower power consumption, and thus the power consumption is reduced. Therefore, the dual hosts sharing peripheral devices can reduce the manufacturing cost without increasing the volume, weight and achieve the goal of power saving.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A computer system with dual hosts, comprising:
a body;
a first host configured in the body;
a second host configured in the body; and
multiple peripheral devices coupled to the first host and the second host, respectively;
wherein the first host and the second host alternatively controls the peripheral devices according to a control priority.

2. The computer system according to claim 1, further comprising:
a switching unit configured in the body and coupled to the first host and the second host and the peripheral devices, for switching the control priority between the first host and the second host to make the first host or the second host control the peripheral devices.

3. The computer system according to claim 2, wherein the switching unit is a multiplexer.

4. The computer system according to claim 2, wherein the control priority is contained in a packet transmitted between the first host and the second host.

5. The computer system according to claim 4, further comprising:
a signal transmitting unit coupled to the first host and the second host, respectively, for transmitting the packet between the first host and the second host.

6. The computer system according to claim 2, further comprising:
an embedded control unit configured in the body and coupled to the first host, the second host and the switching unit, wherein the embedded control unit transmits a first control signal to the switching unit thereby makes the switching unit to choose the first host to control the peripheral devices; or transmits a second control signal to the switching unit thereby makes the switching unit to choose the second host to control the peripheral devices.

7. The computer system according to claim 6, wherein the second host includes a touch panel, and the first host controls the touch panel via the embedded control unit.

8. The computer system according to claim 7, wherein the touch panel is a displayer, and when the second host controls the peripheral device, the second host transmits images to the displayer.

9. The computer system according to claim 1, wherein the peripheral device comprises a display unit, an audio input/output unit, a storage unit and a connecting port.

10. The computer system according to claim 1, wherein the second host is embedded in the first host in a pluggable manner.

11. The computer system according to claim 1, wherein the first host has an x86 architecture, and the second host has an advanced RISC machine (ARM) architecture.
